(19) United States
(12) Patent Application Publication
(10) Pub. No.: US 2013/0135097 A1
(43) Pub. Date: May 30, 2013

(54) Fall-Responsive Emergency Device

(71) Applicant: J&M I.P. Holding Company, LLC, Traverse City, MI (US)

(72) Inventor: Mary Doezema, Traverse City, MI (US)

(73) Assignee: J&M I.P. HOLDING COMPANY, LLC, Traverse City, MI (US)

(21) Appl. No.: 13/751,736

(22) Filed: Jan. 28, 2013

Related U.S. Application Data
(63) Continuation-in-part of application No. 13/812,010, filed on Jan. 24, 2013.

(51) Int. Cl. G08B 21/04

(52) U.S. Cl. CPC G08B 21/0446
USPC 340/539.13; 340/539.11

(57) ABSTRACT

What is provided is a wearable, hands-free emergency alert device that responds automatically to a measurable physical effect of a fall event by the wearer to send an alert signal to a remote responder. The wearable device may be a bracelet with a flex circuit including an accelerometer; a manual alert to signal non-fall emergencies; a microphone and/or audio chip for voice communications between the user of the wearable device and a remote responder; one or more charging contacts so as to allow for induction and/or wireless charging of the device; and a wireless transmitter capable of sending a wireless alert signal in response to a sensed fall and capable of generating a response signal in response to receipt of a ping signal which may be used to determine the device's location.

### CLAIM OF PRIORITY

This application is a continuation-in-part application that claims priority to and the benefit of the filing date of U.S. patent application Ser. No. 13/812,010 filed on Jan. 24, 2013, which in turn claims priority to and the benefit of the filing date of PCT Application PCT/US10/43678, filed on Jul. 29, 2010, both of which are incorporated herein in their entireties by reference.

### TECHNICAL FIELD

The subject matter of the present application is in the field of wearable emergency devices, the devices having capability to alert others at distant locations of the existence of an emergency or a need for assistance experienced by the person wearing the device. These may sometimes also be referred to as “aging-in-place” or “caregiver assistance” devices.

### BACKGROUND ART

Wearable devices capable of transmitting “personal assistance needed” or emergency signals to remote friends, relatives, caregivers, and emergency personnel (hereafter “remote responders”) are generally known. These devices typically require conscious activation of an emergency alert transmitter to notify remote responders of the existence of a medical, personal or other emergency. For example, some devices effectively function as wearable, easy-to-use emergency phones; other devices send a simple alert signal in response to the press of a button or some other deliberate signal activation by the person wearing the device. Persons with potential need for such devices include older adults, individuals living alone, persons with disabilities or chronic diseases, infants in danger of being shaken, and individuals working in high places such as rooftops, ladders or scaffolds.

Prior devices require the person wearing the device to be conscious and able to make a call or activate a signal, to be free of Alzheimer's, Parkinson's or other related diseases affecting the nervous system so they can reach the device, and to generally be in awareness of the emergency situation. Prior devices may also rely on voice communication to indicate the nature of the emergency, which can be limiting in some circumstances. Prior devices may also rely on remote call centers to receive and process calls.

What has been provided in the application to which the present application claims priority, U.S. patent application Ser. No. 13/812,010 filed on Jan. 24, 2013, which in turn claims priority to and the benefit of the filing date of PCT Application PCT/US10/43678, filed on Jul. 29, 2010, is a wearable, hands-free emergency alert device and system that responds automatically to a measurable physical effect of a slip, trip, fall or similar accident or potentially injurious event (hereafter “fall”) by the wearer to send an alert signal to a remote responder. Measurable physical effects include, but are not limited to, movement, vibration, and/or sound.

The wearable device incorporates a fall-sensor capable of recognizing the physical effect of a fall or similar abnormal motion (as distinguished from non-emergency movements and vibrations) and a wireless transmitter that sends a wireless alert signal in response to a sensed fall. The wearable fall-responsive device may optionally include a manual alert to signal non-fall emergencies. The wearable device may send a fall alert signal to a fall response system, such as, but not limited to, that described in PCT Application PCT/US10/43678, filed on Jul. 29, 2010. The wearable device may be used with other fall response systems as well. The fall response system may act to contact one or more remote responders to alert the remote responder that the user of the wearable device has fallen.

In one form the wearable device may be a bracelet. In one form the wearable device senses a fall with a vibration sensor. In another form the wearable device senses a fall with an accelerometer.

In a further form the wearable device may include a microphone, audio chip or wireless two-way voice communicator that may be in signal communication with a fall response system, such as with a base transmitter having a communications portal for initiating a voice communications link between the wearable device and a remote responder. The wearable device might include a voice transmitter and/or receiver to boost the ability of a fallen person to communicate by voice with a local communicator and/or base transmitter of a fall response system, such as, but not limited to, that described in U.S. Ser. No. 13/812,010, filed on Jan. 24, 2013 and/or PCT Application PCT/US10/43678, filed on Jul. 29, 2010.

### BRIEF SUMMARY

The wearable device may contain GPS or other location functionality capable of being used to locate the wearable device and/or track its locations over time. In some examples, the wearable device may be capable of generating one or more response signals in response to a “ping” signal received from a fall response system which may be used to determine its location. In some examples, the wearable device may be capable of generating an alert if it becomes low on power, such as if a battery needs charging, and transmit the low power alert to the system. In some examples, the wearable device may be capable of maintaining signal contact with a fall response system, such that if a fall response system does not receive a signal from the wearable device, the system may generate an alert indicating that the wearable device has moved out of range of the system and/or has lost power.

In a further example, the wearable device may be capable of wireless communications to send device location or other device information to a remote database, such as a cloud or other database, which may be viewable on a web portal from a computing platform display. The wearable device may send this information either directly to a remote database and/or to a fall response system, such as, but not limited to, a base transmitter of a fall response system, for transmission to the remote database.

In a further aspect, the wearable device may include one or more charging contacts so as to allow for charging of its power source (a battery) via induction or other charging, such as with an induction charging plate. It may include a wireless module capable of charging the device remotely with a wireless battery charger.

In a further aspect, the wearable device may comprise a flex circuit.

These and other features and advantages of the invention will become apparent from the detailed description below, in light of the accompanying drawings.

### BRIEF DESCRIPTION OF THE DRAWINGS

FIG. 1 is a perspective view of a wearable device capable of sending a fall-responsive alert signal.

FIG. 1A is an exploded assembly view of the device of FIG. 1.

FIG. 2 is a perspective view of another example of a wearable device.

FIG. 2A is a perspective view of an example flex circuit of a wearable device.

FIG. 2B is a diagram of fabricated layers of the flex circuit example of FIG. 2A.

FIG. 3 is an electrical block diagram of an example wearable device.

FIG. 4A is an electrical schematic of an example wearable device.

FIG. 4B is an electrical schematic of an example wearable device.

FIG. 4C is an electrical schematic of a power management block of an example wearable device.

FIG. 4D is an electrical schematic of a power management block of an example wearable device.

FIG. 5 is a schematic view of a system including the wearable device of FIG. 1 on a premises where a person wearing the wearable device might fall.

FIG. 6 is a schematic representation of a fall event in the system-equipped premises of FIG. 5 and of a chain of signaling and communication between a fallen person and a remote responder.

### DETAILED DESCRIPTION

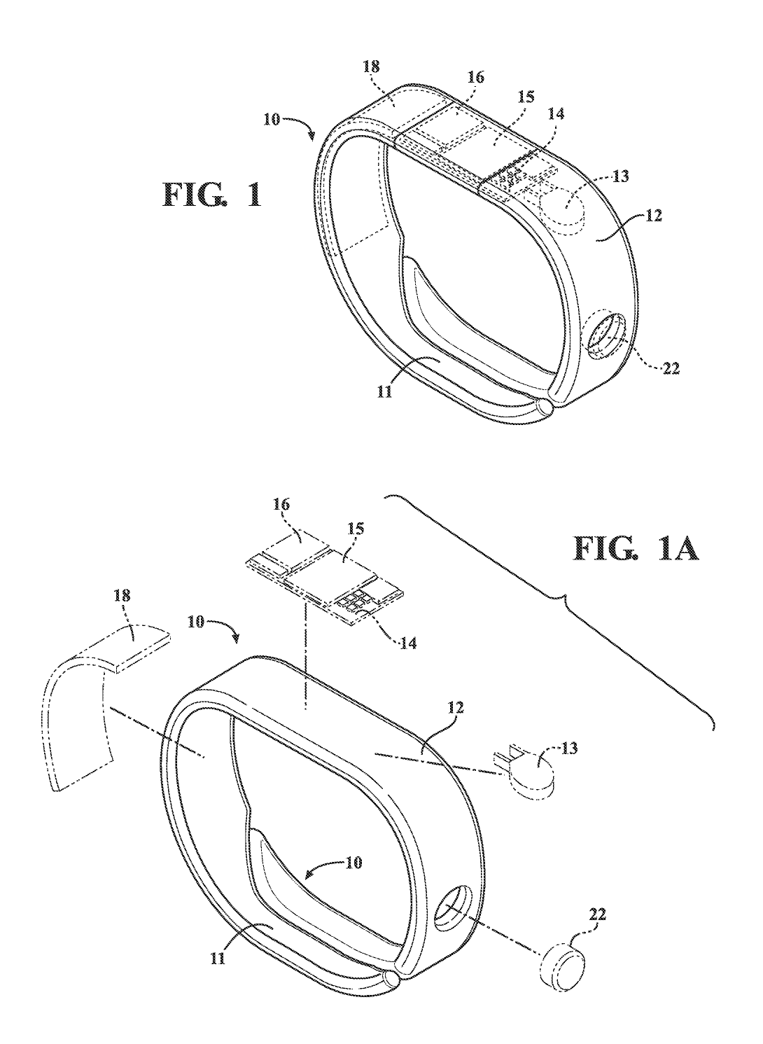

Referring first to FIG. 1, a wearable device 10 is shown in exemplary form. Wearable device 10 is illustrated as a bracelet 12 worn on the wrist, although it may take different forms provided the device is “wearable” or “worn”, i.e. can be carried or worn and retained on a person without conscious effort once donned or applied. Alternate examples of wearable device forms include, but are not limited to, necklaces, rings, pin-on items, belts, watches, belt attachments, bands around the chest, items capable of being carried in a pocket, and articles of clothing.

Bracelet 12 may be made from different materials, in the illustrated form being a combination of metal and polymer materials. Bracelet 12 may be adjustable as illustrated at 11. Bracelet 12 may completely enclose a user's wrist as shown in this example or it may be a cuff style bracelet 12 with an open portion adapted to fit on one or more inner portions of a user's wrist. Other materials and combinations of materials, including precious metals and gems so that the bracelet functions as jewelry or the addition of texting screens for reminders and cueing, are also possible. Some examples may be designed for comfort, since a user may wear the bracelet 12 against his/her skin for an extended period of time and while sleeping. Some examples may be designed for style and/or fashion to have a subjectively attractive external appearance. Bracelet 12 may be constructed of a material having a glossy, luminous surface for its exterior. It may be flexible. It may be abrasion resistant and/or UV stable.

In the illustrated example, bracelet 12 includes a controller device 14, in the illustrated example a chipset housing incorporating one or more chips or integrated circuits; a fall sensor 16 embedded in or otherwise secured to the body of bracelet 12; a battery 18; and wiring 20 contained or embedded in the body of the bracelet to interconnect chipset 14, fall sensor 16, and battery 18 with respect to electrical power needs and signal communication. Chipset 14 may include a wireless transmitter function or a separate wireless transmitter 15 may be incorporated in the bracelet and connected with wiring 20 to chipset 14, sensor 16, and battery 18 as needed. Chipset 14 may also include a GPS chip or other location based functionality and/or USB or micro USB connection capabilities. While the functional components of bracelet 12 are illustrated as being embedded in or otherwise integrated into the bracelet, other methods for securing or attaching some or all of the components should be possible, including external attachments and making the body of bracelet 12 hollow to permit internal mounting of components.

Suitable devices for carrying out the functions of chipset 14, transmitter 15, and sensor 16 are commercially available and known. Chipset 14, for example, may be a CSR BlueCore 5 chipset or Qualcomm/Texas Instruments equivalent. Transmitter 15 may be a standard use 915 mHz, 2.4 GHz, or 6.0 Ghz transmitter of any type commonly used in wireless phone applications. Sensor 16 may be an acceleration sensor or a vibration sensor, such as a VTT or TI standard chip base accelerometer. These examples are currently contemplated, but it should be understood that alternatives exist. Also, chipset firmware 14 can be suitably programmed or encoded to coordinate the interaction of fall sensor 16 and transmitter 15. While a chipset is illustrated as the device for effecting and controlling the functionality of bracelet 12, alternatives and equivalents including, but not limited to, other types of controller, software, hardware, and/or firmware may be suitable.

Fall sensor 16 is responsive to a physical effect of a fall, whether measured by vibration, shock, acceleration, sound, a combination of the foregoing effects, or some other measurable physical effect of a fall as determined to be desirable. These may vary according to the intended use, the intended location, or the expected risk to an end-user wearing the bracelet. In the illustrated example it is assumed that fall sensor 16 is a vibration sensor of the chip-based accelerometer type. Also, more than one type of fall sensor 16 may be incorporated in bracelet 12 to sense more than one physical effect of a fall; for example, a vibration sensor and an acceleration sensor may be used in parallel to sense a wider range of physical effects that would indicate that a fall has taken place.

A fall event may be sensed by the fall sensor 16 in various manners and by various methods. For example, fall sensor 16 may measure the movement activity of a user and determine that a fall event has occurred by the relative measurements of activity, recognizing a fall upon sensing a relatively large impact user activity followed by a period of substantial inactivity, no activity, or substantially reduced activity. Other fall and/or activity measurements are possible by fall sensor 16 to determine the incident of a fall event. For example, a settling time after impact of the initial fall and the subsequent callout time may be measured and timed. One or more algorithms capable of governing the fall event may be manually calibrated for an individual's age, height, physical condition(s), and/or weight. The algorithm may also be calibrated to detect substantially abrupt and/or a very narrow range of abrupt motions that may indicate a stumble or misstep. The algorithm sequence may be expanded to monitor, collect, transmit, store and analyze timing and sequence of motion or minor motion events for predictive purposes. The algorithm may include capturing of horizontal and rotational motions associated with fall events. Other examples are possible.

When someone wearing bracelet 12 falls, fall sensor 16 is activated to generate a sensed-fall signal that is transmitted by wiring 20 to chipset 14 and/or transmitter 15. Chipset 14 responds to the sensed fall signal to activate transmitter 15, which sends a wireless alert signal to an appropriate receiver at a distance from the person wearing bracelet 12. The person wearing the device need not consciously activate the bracelet to generate the wireless alert signal and need not be conscious for the alert signal to be sent—bracelet 12 responds to the sensed physical effect of the fall event without conscious input by the user.

Illustrated bracelet 12 also has a manual alert actuator 22, in the example shown as a recessed button on the inside (or alternately outside) surface of bracelet 12. This can be a button or switch of any type. In the illustrated example, actuator 22 is imbedded in the bracelet housing to maintain a smooth surface contour. It may be activated upon depression and/or after a pre-set time interval of depression (such as 5 seconds). In other examples the actuator may be triggered on/off by the expansion and contraction of the bracelet's hinged side arms when donning or removing the device. In other examples, actuator 22 may be exposed on both the inside and outside of the bracelet so that it must be located and squeezed between the thumb and pointer finger of the user from both sides in order to prevent unintentional activation by bumping or normal activity. Button 22 can be intentionally activated by a person wearing the device to send an alert signal for non-fall events or sudden illnesses or as a backup to the automatic generation of an alert signal by the fall sensor 16.

Button 22 may also be depressed so as to cancel a manual alert inadvertently sent. For example, tapping button 22 after an alert has been sent may trigger a second communication from bracelet 12 to cancel the manual alert. Other bracelet 12 examples may include hand waving functionality for cancelling a manually sent signal so as to cancel the manual alert upon detection of a hand waving motion or continued unintentional arm motions by bracelet 12. Other types of manual alert actuators are possible, including, but not limited to, voice-activated actuators responsive to certain key words.

Some examples may include a waiting period, where there is a pre-set period of time after the fall sensor 16 senses a fall event before the alert is transmitted by transmitter 15 so as to allow for time for a user to manually cancel the alert. In this type of example, button 22 may be used to manually cancel the fall alert before it is transmitted by transmitter 15 instead of to generate and transmit a second cancel signal to the fall response system by transmitter 15.

Bracelet 12 may also be provided with a vibratory output alert 13, in the illustrated example a three-vibe alert triggered by the activation of button 22 to send a vibratory warning to the user that a wireless alert notice is about to be sent from the bracelet to the base station. This gives the wearer an opportunity to cancel the alert signal, for example with another press of button 22, in case the activation was accidental.

In some examples, bracelet 12 may be capable of receiving a “ping” signal from a fall response system by transmitter 16. Bracelet 12 may generate a response signal and send it back to the fall response system via transmitter 16. In this example, the location of bracelet 12 may be determined at least in part based upon the “ping” and response signals. Other examples of bracelet 12 may include GPS or other location based functionality to allow a fall response system or other device or system to locate bracelet 12, track its locations, and/or determine its location history geographically, on a campus, or as zoning in a premises, such as a residence.

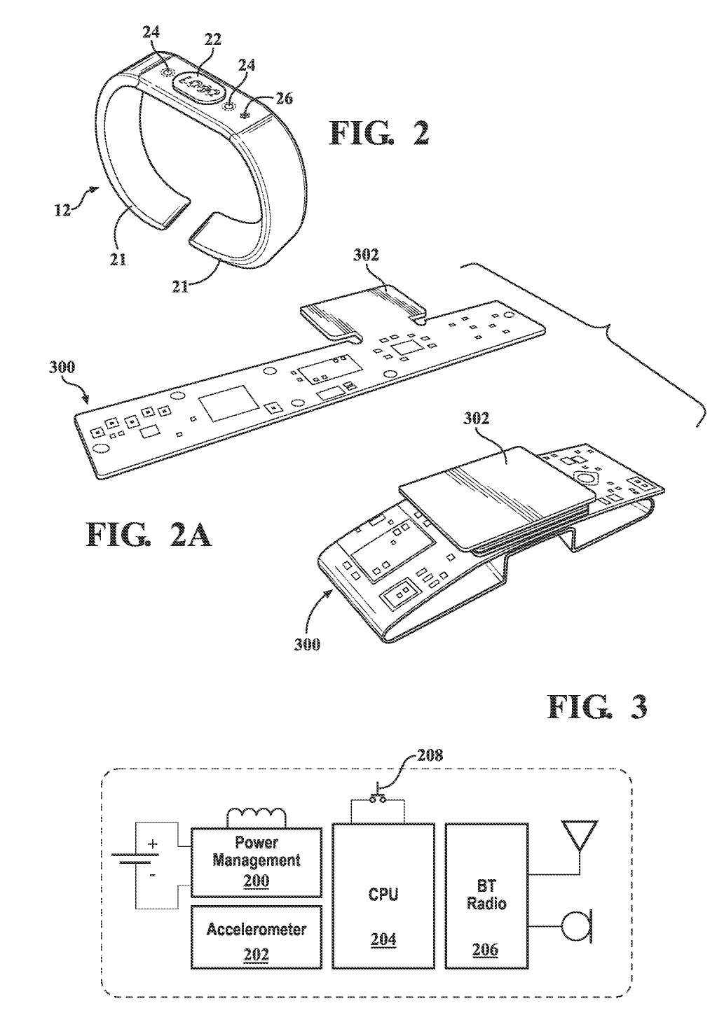

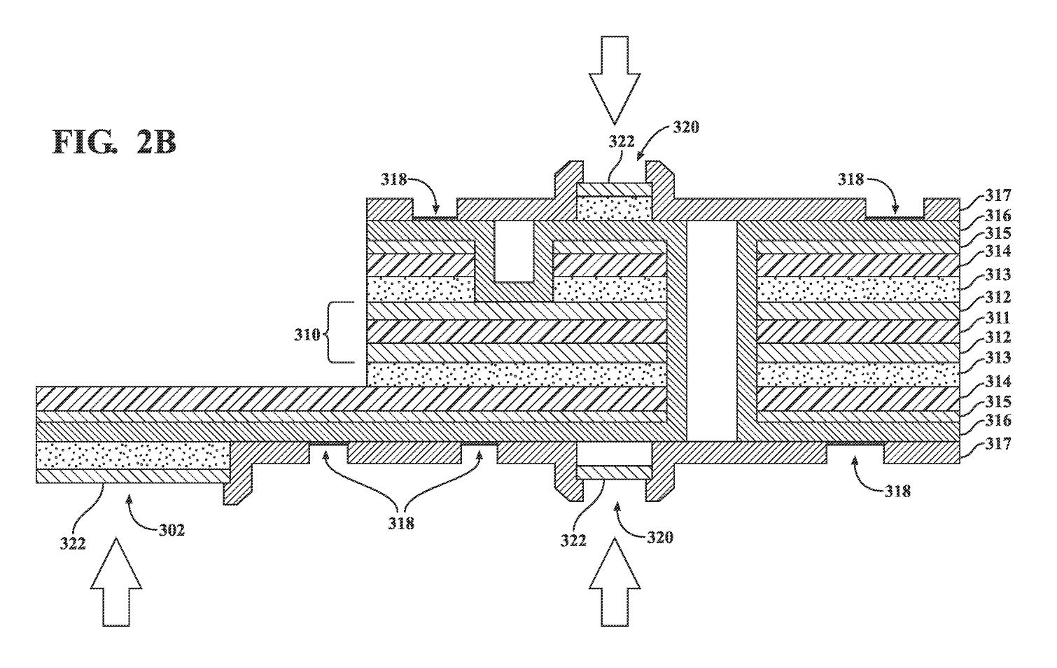

Referring now to FIG. 2, a second example bracelet 12 is shown. In this drawing, bracelet 12 is a cuff style example having an open portion adapted for placement on one or more inner portions of a user's wrist. Bracelet 12 may have one or more hinged side arms 21 capable of expansion and retraction so as to allow a user to put on and/or remove bracelet 12 from an arm. Other constructions of bracelet 12 are possible.

Bracelet 12 may have a fixed size, and various bracelets 12 may be made of different sizes. For example, there may be small, medium and large sized bracelets 12.

Bracelet 12 may have a housing or cover made of any material. Some examples of bracelet 12 may be substantially water resistant so as to prevent water from entering bracelet 12 so that a user may wear bracelet 12 in the bath, shower, swimming pool, for non-submerged bathing and/or in other wet locations. As shown in this example, bracelet 12 may be made of a flexible rubber, rubber-like, plastic, polymer, natural rubber or micromesh screening barrier material which may substantially impede or prevent water from seeping into the cover to the internal components of bracelet 12.

Bracelet 12 may be substantially shockproof. It may be tamper resistant in various examples so as to disable functionality if the cover is opened and/or damaged.

Bracelet 12 may have a power switch (not shown). In some examples, bracelet 12 may include a recessed power switch capable of being used to turn the device on and/or off manually.

Bracelet 12 is capable of sensing a triggering event, such as a fall event, as described with reference to FIG. 1. Other triggering events may include, without limitation, an alert that bracelet 12 has crossed a perimeter or boundary of a fall response system perimeter, an alert that bracelet 12 has moved out of bounds of a fall response system, notice that bracelet 12 has been inactive for a time period, and various other triggering events are possible. Bracelet 12 may be programmed for different triggering events for various users. For example, a fall response system may have different perimeters or boundaries for different bracelets 12 such that perimeter crossing alerts may be triggered differently for various bracelets 12. For example, bracelet 12 may be programmed individually for each bracelet 12 such as to allow for different pre-set time periods of user inactivity allowed prior to sending a user inactivity alert based upon a particular user's activity pattern or desired system uses. As discussed above, bracelet 12 may include firmware, software, hardware and various combinations thereof which may be used to program triggering events for use in a fall response system. Bracelet 12 may also, directly or indirectly through a fall response system, communicate with a remote database server such as for programming of triggering events by a remote responder and/or changes to triggering event settings.

Button 22 is shown, which is a manual switch for a user to manually send an alert to the system. In this example, button 22 may be depressed for a pre-determined period of time to activate a manual alert. For example, button 22 may be depressed for 5 five seconds to activate a manual alert. A manual alert may be cancelled by subsequently depressing button 22 three times repeatedly. For example, two quick depressions of button 22 may act to cancel the manual alert. In other examples, a manual alert may be cancelled by a depression and hold of 10 seconds. The cancellation may generate an alert cancellation signal to send to the system to follow the manual alert. Other examples may act to cancel the manual alert before a manual alert signal is sent to the system. Other manual alert cancellation techniques are possible. In some examples, bracelet 12 may be capable of generating and/or cancelling manual alerts with voice commands. Button 22 may include an illuminated display, such as an LED display. In various examples, the LED may become illuminated upon activation of an alert if bracelet 12 is awakened from a sleep mode or otherwise. In some examples, the LED may include green and red LEDs for indicating a powered “on” mode by green and a powered “off” mode by red. LEDs may be used for indicating Bluetooth connectivity and/or connectivity of bracelet 12 to wireless and/or other communications sources.

In some examples, bracelet 12 may not be operational when in charging mode, such as if placed in charging contact with an induction charger or other charger.

Bracelet 12 may include one or more contact charging points 24 capable of making induction and/or conductive contact directly or indirectly with one or more contacts on a charger, such as an induction charger on a charging plate. Contact charging points 24 may be inside of bracelet 12, a side of bracelet 12, and/or viewable externally so long as they are capable of charging bracelet 22. Contact charging points 24 may be of various shapes and sizes. For various forms of charging, contact charging points 24 may not be required.

The battery/power management of bracelet 12 may allow it to remain operational for a 24 hour period of time in some examples. Other battery life examples are possible. Power management may include a sleep mode for bracelet 12, such that bracelet 12 may conserve battery power and wake up upon receipt of a signal and/or depression of button 22. Bracelet 12 may be capable of sending one or more signals including battery status information, such as via Bluetooth or other radio signals to a fall response system and/or WIFI, cellular or other wireless signals to a remote database server such as that of a fall response system.

Bracelet 22 may include a microphone 26 and an audio controller (not shown) which may be used for voice communication, such as two-way telephonic or VOIP voice communications in conjunction with a communications portal in a fall response system or other communications system, such as for voice communications between a remote responder contacted by the fall response system and the user of bracelet 12. In this example, bracelet 12 may receive such signals via Bluetooth protocol, but other wireless protocol, such as, but not limited to, cellular, WIFI or other wireless communications protocol known in the art, is possible in various examples.

The cover of bracelet 12 may have one or more venting holes so as to provide comfort to a user wearing the device. The cover may include one or more vents or openings for one or more ports capable of being used for connecting external devices, such as, but not limited to, a power cord, an adapter cord or a USB or proprietary connector, to bracelet 12.

As shown in FIG. 2A, bracelet 12 may include a flex circuit 300 inside of the cover or housing which contains the functional components of bracelet 12 thereon. The flex circuit 300 is a flexible circuit board which may be fabricated in multiple layers having connectivity there between by techniques known in the art. As shown in FIG. 2A, the flexible circuit 300 may be bent and/or folded so as to allow for placement within an outer shell, cover or housing of bracelet 12. It may include a flap 302 upon one or more layers for inclusion of a battery. Various layers may be of the same size and shape and/or one or more layers may have a different size and shape from the others. For example, flex circuit 300 may be made of four layers, including three layers of the same size without flap 302 and a fourth layer that is larger having flap 302. The fourth layer may be an outer layer in this example. The outer layer, the fourth layer in this example, may also include one or more external port interfaces, such as a micro USB port capable of being used to connect external devices and/or power sources to bracelet 12. It may be made in accordance with IPC-6013, Class 2, IPC-A-610 and/or IPC-A-600 criteria, but other fabrication methods, requirements, specifications and the like known in the art may be used.

Flex circuit 300 may include holes fabricated in different layers so as to allow for electrical connectivity between layers. Flex circuit 300 may be a printed circuit board and have a solder side and a component side. It may have exposed pads that are electroless nickel and/or immersion gold plated. Flex circuit 300 may be constructed by fabrication techniques known in the art, including but not limited to, masking, plating and solder coating.

As shown in FIG. 2B, it may have a core 310 comprising a polyimide layer 311 located between two base copper layers 312. In this example, base copper layers may have a thickness of approximately 18 um and polyimide layer 311 may have a thickness of approximately 20-25 um. There may be adhesive layers 313 of approximately 25 um thickness located adjacent the base copper layers 312. There may be polyimide layers 314 adjacent the adhesive layers 313, followed by a base copper layer 315, a plated copper layer 316 and a solder mask layer 317. In this example, the polyimide layers 314 may be of a thickness of approximately 20-25 um, the base copper layers 315 may be of a thickness of approximately 12 um, the plated copper layers 316 may be of a thickness of approximately 20 um, and the solder mask layer may be of a thickness of approximately 20 um. The base copper layer 315 and polyimide layer 314 may comprise a single sided base material adhesively connected to the core 310. Other base materials are possible as known in the art. Flex circuit 300 may include one or more component pads 318 in solder mask layer 317, as shown in FIG. 2B. There may be a bend zone 320, such as where the circuit is likely to experience bending within a housing of bracelet 12 and/or while in use upon a user's arm. There may an additional coverlay layer 322 in the outer layer of flex circuit 300, such as for flap 302 and/or the micro USB port. In this example, coverlay 322 may have a thickness of approximately 12.5 um. Coverlay 322 may be made of a polymer. Of course, other thicknesses, numbers of and arrangement of layers, conductive and non-conductive layer materials, and the like are possible for flex circuit 300.

FIG. 3 shows an example block diagram of components of a bracelet 12. Bracelet 12 includes a power management block 200 which contains functionality for providing one or more relatively stable power supply rail to circuits within bracelet 12 components. Power management block 200 may act to provide relatively stable 2.5V and 1.8V power rails in this example. Power management block 200 controls power discharge and battery charging, such as via inductive charging on a charging plate. Power management may include an inductively coupled source of charging that may charge the battery. Other charging types are possible. Power management block 200 may prevent and/or reduce overcharging of the battery and/or limit one or more discharged rates of the battery. Power management block 200 may protect the battery from under voltage operation and/or disable operation for input voltages, such as those less than 2.8V. In this manner, power management block 200 may provide “sleep” and “wake” modes for bracelet 200. Power management block 200 may protect the battery from overcharging, such as by limiting input voltage to 4.2V maximum. Other charging limits and tolerances are possible. This is merely but one example. The battery in bracelet 12 may be a lithium ion battery in this particular example, but other battery types of various capacities are possible.

Power management block 200 may be capable of determining if battery power is low. It may be capable of communicating low battery power information to a CPU 204 for generation of a lower battery alert. A low battery alert may be an alert for the user of bracelet 12, such as a visual LED alert and/or vibratory alert. It may be an alert for transmission to a remote responder to alert the remote responder of the battery power situation.

In this example, bracelet 12 includes an accelerometer 202. Accelerometer 202 may convert motion of bracelet 12 into electrical signals readable by CPU 204. Accelerometer 202 may have a three axis (X,Y,Z) detection. Accelerometer 202 may have a serial interface in this example. It may have an output resolution of greater than or equal to 10 bits. Other tolerances, settings and examples are possible.

Accelerometer may operate using various fall event detection and/or prediction algorithms. Various movement types may be detected by examples, including acceleration and/or deceleration movements, a large movement followed by relatively substantially small, low and/or no movement, twisting motions, horizontal motions, vertical motions, abrupt motions, and others. In some examples, a user's body position and/or location may be detected and/or predicted based upon the movement and/or location determining functionality of bracelet 12.

Bracelet 12 may include a CPU 204 which may carry out the functionality of bracelet 12. CPU 204 may have a sleep current consumption rate and/or amount and a higher operating current consumption rate and/or amount. CPU 204 may have adequate speed to support radio throughput and latency of bracelet 12. CPU 204 may have electrical interfaces to Bluetooth radio 206, accelerometer 202, switch interface, power supply management block 200, memory, and/or other components of bracelet 12.

Bracelet 12 includes Bluetooth radio block 206. The Bluetooth radio 206 may provide for communications between bracelet 12 and other devices, such as cellular telephones, local communicators of the fall response system, and/or other system components or external devices. This example may use Bluetooth 4.0, which may be considered a low energy capability application. Bluetooth radio 206 may have output power of greater than or equal to 6 dBm and operate in compliance with FCC SAR limits. Bluetooth radio 206 may be set to have a receive sensitivity of less than or equal to 90 dBm in this example. Other settings are possible. Bluetooth radio 206 may have a small physical size so as to fit within the design and/or flex circuit of bracelet 12.

Bluetooth radio 206 may be capable of communicating location information of bracelet 12, such as by ping/response signal functionality, GPS chip or other location based functionality. The body position of a user wearing bracelet 12 may be determined based upon the location functionality and/or fall algorithm functionality and this also may be communicated by Bluetooth radio 206. Bluetooth radio 206 may be capable of communicating alerts to one or more remote responders.

There may be an I/O interface 208 which interfaces the internal circuitry and functionality of bracelet 12 to human interface devices. I/O interface 208 may include a push button switch for button 22 (shown with respect to FIGS. 1 and 2) which may be used to put bracelet 12 into an awake mode (from a sleep mode), trigger a manual alert, cancel a manual alert, or for other functions. The push button switch of I/O interface 208 may include an illuminated display, such as a LED display.

I/O interface 208 may also include a microphone and/or microphone/speaker combination for use in one or two-way voice communications between a remote responder and a user of bracelet 12. For example, I/O interface 208 may includes an electret omnidirectional microphone having a frequency response of 300 hx-8 khx (human voice range only). I/O block 208 may include an actuator, such as a button and a touch sensor, such as for creating and/or cancelling manual alerts. Other examples are possible, and claimed subject matter is not intended to be limited to a particular microphone, button or I/O device.

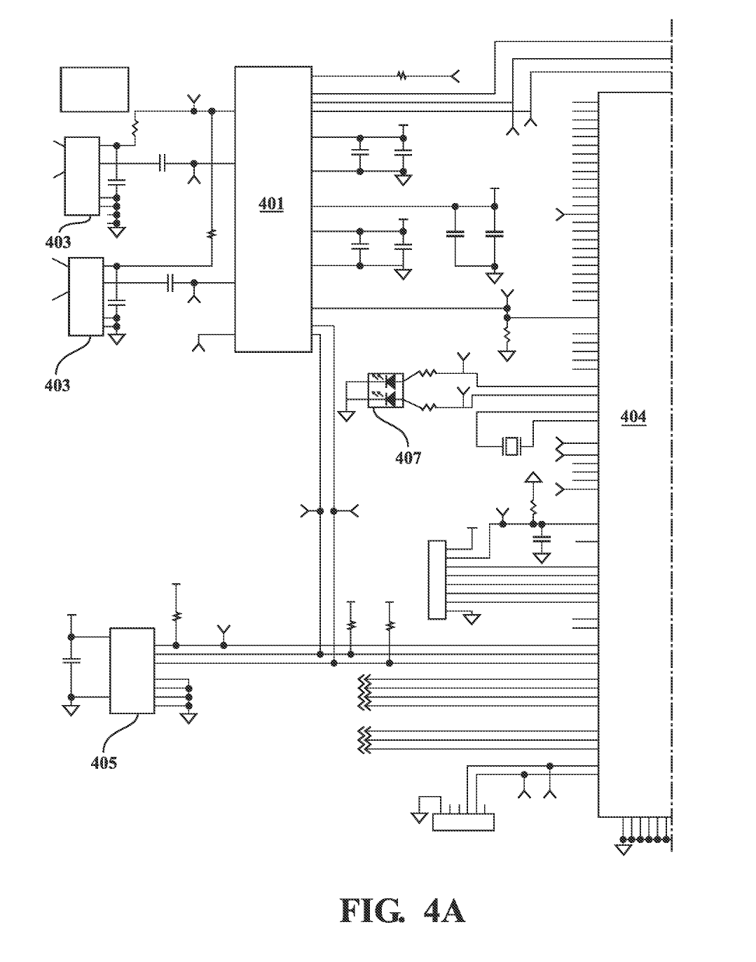

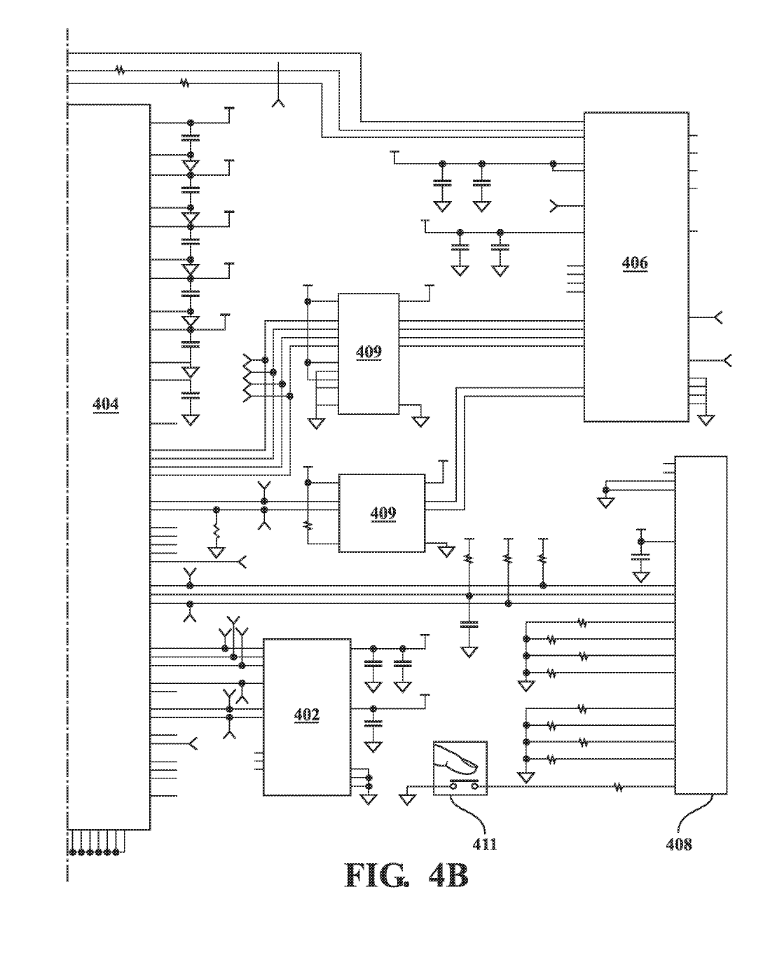

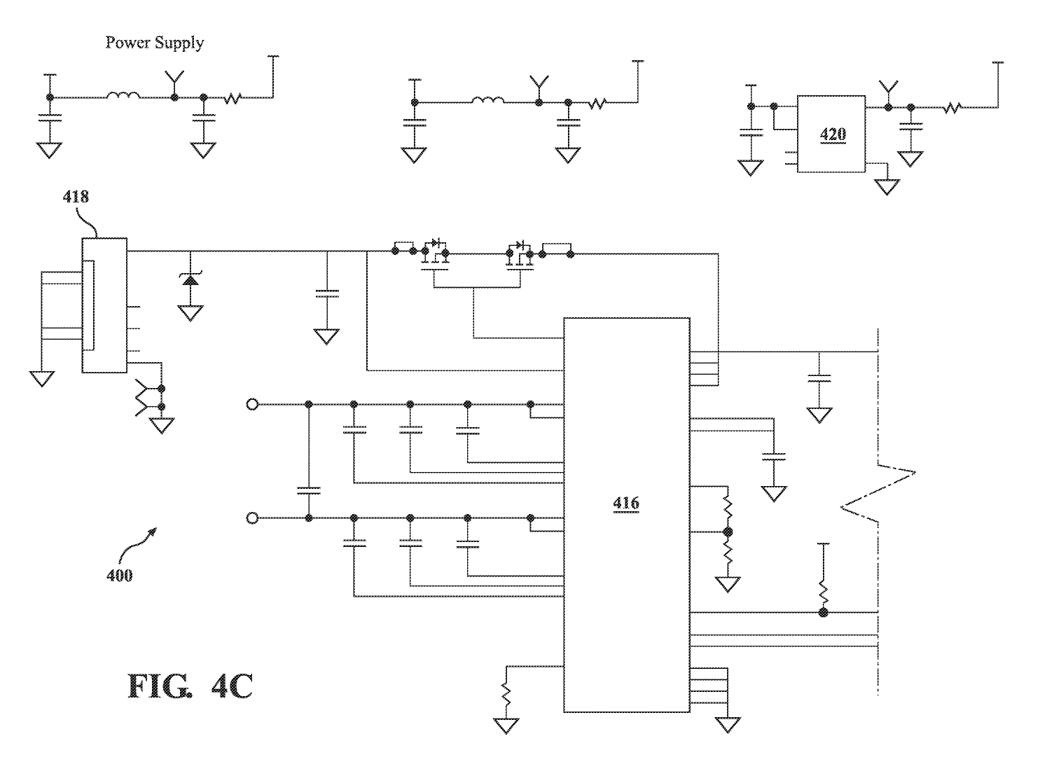

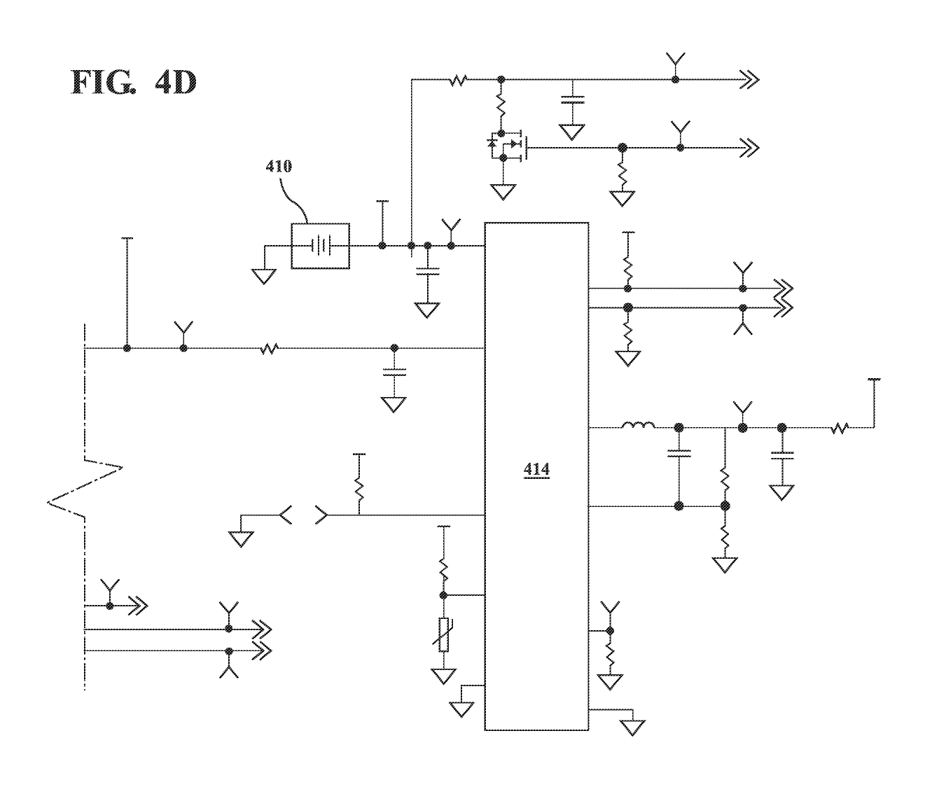

FIGS. 4A and 4B are electrical schematics of components of an example wearable device that may be arranged as a flex circuit. Bracelet 12 may include a CPU 404 which may function to control functionality of bracelet 12, as described above with respect to FIG. 3. For example, CPU 404 may be a Samtec CLM Series device. Others are possible.

The functionality of bracelet 12, as described with reference to this figure, may operate at least in part by use of CPU 404 which may comprise a central processing unit, such as a microprocessor or microcontroller for executing programs, performing data manipulations, and controlling the tasks of bracelet 12. CPU 404 may manage input/output, perform floating point mathematical operations, manage digital signals, perform fast execution of signal processing algorithms, operate as a back-end processor and/or a slave-type processor subordinate to another processor, operate as an additional microprocessor and/or controller for dual and/or multiple processor systems, and/or operate as a coprocessor and/or additional processor. Auxiliary processors may be discrete processors and/or may be arranged in the same package as the main processor, for example, in a multicore and/or multithreaded processor; however, the scope of the claimed subject matter is not limited in these respects.

Bracelet 12 may include an audio chip 401 for controlling voice communications to/from bracelet 12. In this example, audio chip 401 is a Texas Instruments WSCP-16 type audio ADC, but other examples are possible. Audio chip 401 may function with one or more microphones 403 to allow for voice communications from a user of bracelet 12 to be transmitted from bracelet 12. In this example, there are two microphones 403 which are Knowles Acoustics SPU04 Series. Others are possible. Voice communication input by microphones 403 may be converted to voice or audio signals by audio chip 401. The voice or audio signals may be sent to a remote responder, such as if the bracelet 12 is in signal communication with a fall response system via the Bluetooth Radio 406 (discussed below). Audio chip 401 may support two-way voice communications in some examples having one or more speakers and/or comprise a codec.

There may be an illumination source, such as LED 407, which may be controlled by CPU 404. In this example, the LED is a Kingsbright APTB 1612 Series LED, but other LEDs or other types of illumination sources may be used. Other examples may not include an illumination source. The illumination source may indicate that the bracelet 12 is in an active mode, illuminate upon the generation and/or transmission of an alert, or otherwise.

CPU 404 may be connected to memory 405, such as an EEPROM chip memory. Memory 405 may be used as short-term storage needed for carrying out bracelet functionality by CPU 404. Memory 405 may be used for storage of data, such as, but not limited to, user information, system information, fall algorithm information, alert information, fall or emergency event history information, device location information, firmware, software, integration instructions for integrating bracelet 12 with other devices and/or systems, an operating system, and other information. Memory 405 may enable storage and retrieval functionality. Memory may provide storage of instructions and data for one or more programs to be executed by the processor, such as instructions for generating an alert signal upon receipt of a sensed-fall event from accelerometer 402, executing receipt and transmission of communications via Bluetooth radio 406, and/or other functionality of bracelet 12. Memories may include semiconductor based memory such as read-only memory (ROM), programmable read-only memory (PROM), erasable programmable read-only memory (EPROM), electrically erasable read-only memory (EEPROM), flash memory, and/or any block oriented memory similar to EEPROM. In this example, a 64 k serial EEPROM IC chip that is a Microchip TDFN-8 model is used, but other memories are possible. Memory may comprise, for example, semiconductor-based memory, such as dynamic random access memory (DRAM) and/or static random access memory (SRAM), and/or the like. Other semi-conductor-based memory types may include, for example, synchronous dynamic random access memory (SDRAM), Rambus dynamic random access memory (RDRAM), ferroelectric random access memory (FRAM), and so on. Auxiliary memories may be utilized to store instructions and/or data that are to be loaded into the memory before execution.

As described above, accelerometer 402 may sense fall events and communicate them to CPU 204. In this example, accelerometer 402 is an Analog Devices LGA-14 accelerometer IC having 3-axis sensing. Others are possible.

Bluetooth radio 406 may be used to send alert signals as directed by CPU 404. In this example, a Panasonic Bluetooth ENW-89823A2JF module is used, and others are possible. Bluetooth radio 406 may be used to receive signals, such as “ping” signals from a local communicator or other system device and/or other external devices, and translate them into signals understandable by CPU 404 which may trigger functionality by CPU 404 to generate one or more response signals for transmission by Bluetooth radio 406 as described above. Bluetooth signals may be used to determine the location of bracelet 12. Other examples may include a GPS chip (not shown) capable of being used to alert a fall alert system or other external device or system of the location of bracelet 12.

Bracelet 12 may include level shifters and/or bus transceivers 409 for communications between Bluetooth radio 406 and CPU 404. In this example, a Texas Instruments UQFN-16 dual supply bus transceiver and a DSBGA-8 IC bus transceiver are included. Communication with CPU 404 may be implemented via a bus for transferring information among the components of the computing platform. In various examples, a bus may include a data channel for facilitating information transfer between Bluetooth radio 406 and/or other peripheral components of bracelet 12. A bus may further provide a set of signals utilized for communication with CPU 404, such as translation of Bluetooth signals into a format understandable by CPU 404.

There may be a touch sensor 408 in communication with CPU 404 to communicate manual user operations, such as powering on bracelet 12, awakening bracelet 12 from a sleep mode, generate a manual alert and/or cancel a manual alert. In this example, touch sensor 408 is an Alsentis QFN-16 4 mm IC with 5 inputs. Touch sensor 408 may be activated by a touch pad 411, such as a switch with a capacitive touch operation.

As shown in FIGS. 4C and 4D, power management block 400 may include a battery 410. In this example, battery 410 is a Powerstream 3.7V lithium polymer battery. There may be a main regulator 412 for carrying out the power management functionality regarding charging and output. Battery charger 414 may be integral with main regulator 412 and/or a separate component in various examples. In this example, battery charger 412 is a Linear Tech DFN-10 IC. Battery charger 414 may act to charge battery 414, such as by induction charging using one or more conductive or electrical contacts on bracelet 12. Battery charger 414 may include wireless charging 416, allowing for a remote charging of bracelet 12 not requiring that it be placed upon or physically connected to a charger. In this example, a Texas Instruments DSBGA-28 wireless power receiver is used, but others are possible. Battery charger 414 may also be capable of charging battery 410 via external power from a standard micro USB port 418. Other types of ports are possible which may work with adapter cords to plug into another device and/or an electrical outlet for charging bracelet 12. There may be a low voltage regulator 420, such as a Texas Instruments SON-6_{—}1P5mM_VIAS IC 1.8V model.

Of course, various resistors, capacitors, thermistors, transistors, connectors and other wiring and electronic components known in the art may be used to electrically connect the various bracelet 12 components in accordance with this schematic example and/or others. Other layouts and electrical connections are possible.

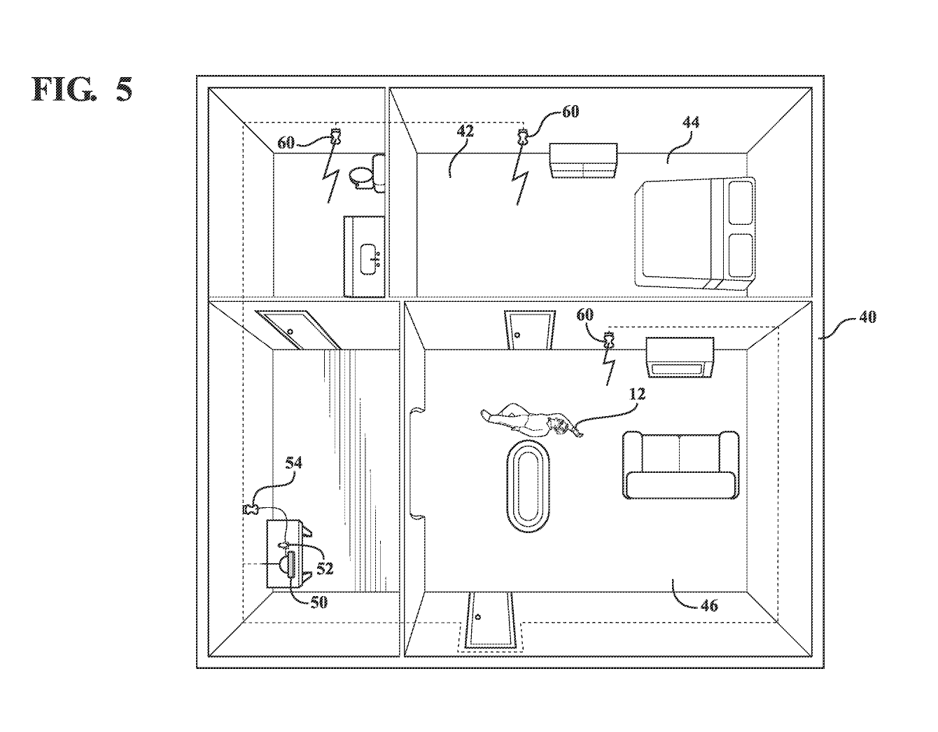

Referring next to FIG. 5, a premises 40, such as a house, is equipped with a system that incorporates bracelet 12 that responds to the wireless alert signal produced by bracelet 12 during a fall event. Premises 40 has one or more possible fall locations; for example, a bathroom 42, a bedroom 44, and a living room 46. A base transmitter 50 is located on-premises and contains or is connected to communication gateway 52 for communicating with one or more remote responders who may be off-premises. While FIG. 5 depicts a communication gateway 52 external to base transmitter 50, other examples include this functionality internally within base transmitter 50.

For example, base transmitter 50 may include Ethernet and/or telephone ports and communicate with one or more responders via direct or indirect connection to a telephone, Internet access or other data transmission line. In other examples, base transmitter 50 may use wireless technology known in the art to connect to a router, modem or other device to obtain telephonic, Internet or other data transmission access. Base transmitter 50 may communicate with remote responders by Bluetooth, cellular, WIFI or other wireless communications technology known in the art. Base transmitter 50 may act as an Ethernet enabled wireless gateway or router to provide interaction with other system components, such as a web-based portal, mobile device, wireless headset or earbud, telephone, mobile application and others to communicate with remote responders. For example, base transmitter 50 may contain Wireless M-bus functionality or other wireless or WIFI capabilities know in the art. Other protocols are possible. In this manner, base transmitter 50 may interface the system 500 to the outside world.

In the illustrated example, base transmitter 50 is a device that receives an RF signal from an associated device, in this case local communicator 60. However, other types of wireless signals are possible for communications between base transmitter 50 and local communicators 60. For example, base transmitter 50 and local communicators 60 may communicate via Bluetooth wireless signals or other protocols known in the art.

Once activated, the internal programming of base transmitter 50 may call one or more (e.g., five) pre-determined and programmed telephone numbers or send programmed text messages or otherwise make a contact attempt with a remote responder using any known and conveniently used form of communication, such as, but not limited to, a web portal, telephone and/or mobile application. Base transmitter 50 may use a call service and/or Internet based calling technologies and functionality, such as a PBX service, for detecting a communications connection with a remote responder and/or an IVR or other system to detect whether a person or machine, such as computerized voicemail, have answered the line so as to attempt to reach a live person if the communication is telephonic. Ethernet based calls may use VOIP or other voice transmission protocols. In various examples, base transmitter 50 may initiate contact with the pre-programmed contacts in a set order, all at once, and/or in batches.

In one example, once the communication and/or signal is received by a remote responder, he or she may hear a pre-recorded alert message from the system indicating that a fall event has occurred, and the base transmitter 50 may open two-way communication between the remote responder (via the communications link) and the local communicator 60 (via its transceiver and speaker functionality). If the remote responder does not answer or receive the communication, base transmitter 50 may initiate communication to a second remote responder contact (which may be a second contact number for a particular remote responder and/or contact information for a different remote responder), and so on, and so on, if more than one remote responder contact information is programmed into system 500. If no remote responder in the pre-programmed list answers/receives the communication, base transmitter 50 may be programmed to contact emergency personnel and/or a call center.

In another example, once the communication and/or signal is received by a remote responder, he or she may manually enter a form of pre-programmed coded message, for example either a number or letter combination (similar to remotely checking your voice mail). Once the proper code is entered, the base transmitter 50 opens communication between the fallen person via the local communicator 60 and the responder. In this example, two-way voice communication between the remote responder and the local communicator is not automatically initiated. If no code is entered, base transmitter 50 can be programmed to call a call center or emergency services.

In a further example, once a communication link is established, base transmitter 50 may open up two-way communications between the remote responder and only the local communicator 60 nearest the user of bracelet 12. Base transmitter 50 may employ Bluetooth or other wireless protocol to connect the remote responder to the local communicator 60 that sent the fall alert signal via radio or other wireless protocol to base transmitter 50 to indicate a fall event.

Other examples of system may include more than one bracelet 12. Each bracelet 12 may have its own unique identifier so that system 500 may identify the locations and fall events or other triggering events associated with a particular bracelet 12. For systems with multiple bracelets 12, base transmitter 50 may include communication portals separately for each bracelet 12 so as to be capable of multiple communications at once for different bracelets 12 substantially simultaneously. Other examples may have a single communications portal for events of all bracelets 12.

Other triggering events may include bracelet 12 moving out of range of system 500, in which case an alert may be sent from the system to a remote responder. In this manner, the local communicators 60 of the system may establish one or more boundaries or perimeters. In order to determine whether bracelet 12 is within range and with power, local communicators 60 may send a signal to “ping” bracelet 12 at various preset intervals. If the “ping” signal detects bracelet 12, the location of bracelet 12 within the system may be recorded. If the “ping” does not detect bracelet 12, the system may send an alert to a remote responder. Other examples may include bracelet 12 sending a response signal to local communicators 60 in response to receipt of the “ping” signal. Failure by local communicators 60 to receive the response signal may trigger an alert. Failure by local communicators 60 to receive a response signal from bracelet 12 may indicate that bracelet 12 has moved out of range of the local communicators 60 of system 500. It may also indicate that bracelet 12 has lost power in some examples.

A further triggering event may be that bracelet 12 remains in one location for a pre-determined period of time. This may cause an alert to be sent by the system to a remote responder. This functionality may help a remote responder discover if a user has taken bracelet 12 off and/or is immobile, unconscious or needs assistance.

A further triggering event may be that bracelet 12 is low on and/or loses power which may indicate that it needs to be charged. If bracelet 12 is low on power and/or loses power, the bracelet 12 may send a signal to the system, which in turn may send an alert to a remote responder.

In the illustrated example of FIG. 5, communication gateway 52 is a telephone communicating with the outside world by landline 54, but as discussed above, wireless and other communications are possible, and claimed subject is not limited to landline embodiments of the system. In addition to those discussed above with reference to FIG. 5, other possibilities for the remote communication gateway 52 may also include, but are not limited to, cable modems, satellite dishes, mobile phones, or long-range RF transmitters. The connection between base transmitter 50 and the remote communication gateway 52 may be wireless or wired.

If a person wearing bracelet 12 should fall on premises 40 (or another triggering event occurs), bracelet 12 sends a wireless alert signal that is received by the base transmitter 50 or that is relayed in original or modified signal form by an intermediate device to base transmitter 50. Base transmitter 50 is then enabled to request the intervention or assistance of a remote responder by sending a predetermined remote responder request via phone 52. Again, phone 52 shown in FIG. 5 is merely one example of a possible communicator, and others are possible. The remote responder request can be any signal or message capable of being transmitted off-premises and being recognized by a remote responder (human or automated), for example a pre-recorded voice message, an email or text, a distinctive tone, or a machine-readable alarm signal. In situations and on premises where a remote responder may be within hearing of the premises 40, one possible remote responder request could be a tactile alarm that is audible or visible from off-premises.

It will also be understood that “on-premises” and “off-premises” could be locations included in a single dwelling or building not normally in communication with each other, for example two different apartments in an apartment building or two different floors in a skilled nursing or rehabilitation facility, dementia care or assisted living facility or senior residential community or continuum of care facility, a hospital or a medical clinic, such as, but not limited to, where a remote responder is located far enough from the person wearing bracelet 12 that he or she would not be likely to hear a fall event and would need to be notified via base station 50 of the event. Of course, system 500 may be used if a remote responder is in the same premises, proximity and/or room in a dwelling, vehicle or other place with the user of bracelet 12.

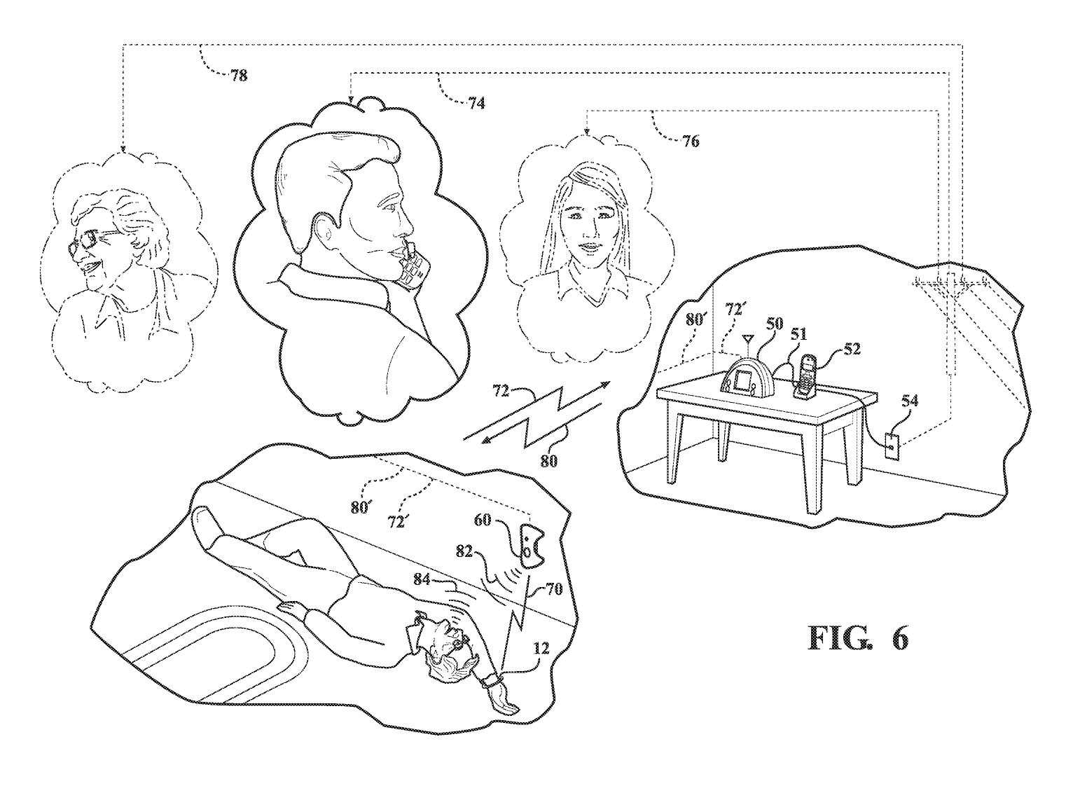

Referring next to FIG. 6, the system also includes one or more local communicators 60 mounted in various stationary locations on the premises 40 within voice communication distance of possible fall locations. Communicators 60 are stationary in use, although they need not be permanently fixed in place and could be moved to different locations for optimum voice communication based on testing and/or as needed on the premises given anticipated fall locations. Examples of stationary locations include, but are not limited to, direct plug-in connection in electrical outlets, wall-mounted locations, furniture-mounted locations, and attachment to or incorporation into appliances, or automobiles or aircraft.

In the illustrated example of FIG. 6, a person wearing bracelet 12 has fallen in a room of the house 40 different than the room in which base station transmitter 50 is located. Bracelet 12 senses the fall and sends a wireless alert signal 70 to two-way local voice communicator unit 60 mounted in a wall outlet in the room where the fall occurred. Local communicator 60 in turn either relays the fall alert signal or sends a fall notification signal (hereafter both referred to as “notification” signal) to base station 50 via wireless signal 72 and/or wire-transmitted signal 72′. Base station 50 is enabled to generate a responder request signal which is transmitted through connection 51 (wired or wireless) to remote communication means 52 (a telephone or modem) which sends the request off-premises via communication link 54 (landline). The remote responder request is sent to at least one predetermined responder R1 and preferably to additional responders R2, R3, . . . , over respective communication links 74, 76, and 78. For example, the phone/modem 52 dials five pre-programmed telephone numbers in preset order. The remote responders' telephone or other contact connections (email, fax, mobile phone, text) are programmed into the base station transmitter 50 or the remote communication means 52.

In the illustrated example of FIG. 6, one remote responder R1 is available and gives a response to the request for assistance, while responders R2 and R3 are unavailable and do not. Responder R1 is shown having received the request by telephone call, for example a prerecorded voice message such as “John, it's me, I need help. Please call me back at telephone number xxx-xxx-xxxx.” In various examples, there may be a system message, such as, “Fall-Responsive Emergency System Event. Please call back.” When responder R1 acknowledges that the call has been accepted by an authorized responder, for example by entering a numeric code via the phone keys to notify the system that the call has been accepted by an authorized responder and/or more directly by placing a return phone call, via link 74, 54, 52, and 51, base station 50 activates at least the nearest, and optionally all, of the local communicators 60 on the premises via wireless and/or wired signals 80, 80′. The fallen person wearing bracelet 12 and responder R1 can then communicate directly by voice through the nearest local communicator 60, even if the fallen person is immobile as represented at 82, 84. For premises where there might be communication-interfering noise in rooms other than where a fall occurred, it would be possible to choose and program a protocol for activating only the local communicator 60 nearest to the fallen person, for example by sensing the fall signal strength or the distance of bracelet 12 from each of the local communicators 60 on the premises 40. In other examples, the two-way communication may be automatically opened upon call connection to a live person without requiring entry of a code by the remote responder. In other examples, two-way communications may be between bracelet 12 using its microphone and audio chip capabilities. Other examples are possible.

This is but one possible example system and use for bracelet 12. Other fall response systems of various different components and functionality may be used with bracelet 12.

The bracelet may be used to signal personal emergency events in addition to and/or instead of fall events. It may be used for personal safety. For example, the bracelet could also be used by mothers with infants in danger of being shaken by childcare providers or inexperienced babysitters. The set point or sensitivity of the fall sensor, for example an accelerometer, could be adjusted to detect a repeated, violent shaking and prompt an alert signal when worn on the ankle of an infant. Many other applications are possible.

The bracelet may be used for locating individuals on a premises and/or off of a premises. For example, military applications may include soldier tracking during combat or other operations using bracelet 12 to communicate to command operations the locations of users and/or their movement activity within a vessel, battlefield, area and/or globally.

The bracelet may be used for fall events occurring as result of internal health conditions of a user or fall events from external, environmental and/or situational factors, events or forces. For example, internal health conditions that could contribute to and/or cause a fall event may include stroke, heart attack, low blood sugar, lack of oxygen, dehydration, and others. Fall events may be due to external factors, such as actions or movement by the user, non-action of the user, and/or choices of a user (such as over-medication, under-medication, mis-use of medication, intoxication, side effects from contraindication causing dizziness or confusion). Other external factors are possible. These external events may cause personal emergency events instead of and/or in addition to fall events.

Environmental factors may happen inside a home, workplace, hotel room, dorm or other places around a user of the bracelet. Environmental factors may include, for example, poor lighting, slippery rugs, wet floors, doorway lips, ladder climbing, or stairs. Environmental factors in the outdoors may include wet steps, snowy walkways or driveways, open patios, porches without railings, etc. Environmental factors may be present in or outside of a premises or out and about while running errands, going to work, visiting, traveling, etc. The present bracelet may be used for these applications. Environmental factors may cause fall events and/or personal emergencies. For example, bracelet 12 may send an automatic or manual alert if a user falls due to an external force being applied, such as if in a car accident, boating accident, a tree limb or other object fall on and/or knocks a user down, or other external forces. Bracelet 12 may be used to notify a remote responder of fall or other emergency alerts and user location information associated with activities, such as, by way of example, a skiing accident, mountain climbing fall, hiking injury, and many more. Bracelet 12 may be used to communicate user location information and emergency information from earthquakes or other natural disaster, house fires, or other emergency situations.

Situational factors may include physical disability of a user, sensory or memory limitations of a user, mobility issues of a user, physical challenges of a user, and the like. Various examples of bracelet 12 may allow for customizable programming to account for such situation factors via the user profile. This information may be used by bracelet 12 in determining and/or predicting fall events.

Situational factors may also include personal safety factors, such as muggings, attacks, bullying, robbery, assault and the like. Outside physical forces, such as, but not limited to, pushings, shovings and kickings, may be factors leading to a personal emergency event contemplated by the present system. Psychological conditions, such as fear, may cause a fall event and/or be a symptom of a personal emergency event. Both the automatic and manual alert capabilities of the bracelet may be used in such situations. For example, a child may use bracelet 12 to communicate falls or stumbles due to being pushed (such as from bullying activity) to alert a remote responder as to the child's location and/or to allow a child to manually send an alert communication in situations where the child senses an emergency.

Bracelet 12 may be used for reverse security, such that a person entering a premises or crossing perimeter and/or boundary area without a bracelet 12 may trigger an alert, such as for applications including intruder detection, security system, or to inform a remote responder of an unauthorized visitor on a school campus. Many other applications are possible.

In the preceding description, various aspects and examples and configurations of making and using the invention as defined by the claimed subject matter have been described, for purposes of explanation, to provide a thorough understanding of claimed subject matter and to enable those skilled in the art to make and use claimed subject matter. However, these are merely example illustrations and descriptions of inventive concepts, and other illustrations may apply as well, and the scope of claimed subject matter is not limited in these respects. It should be apparent to one skilled in the art having the benefit of this disclosure that claimed subject matter may be practiced without being limited to the specific details of the disclosure. In other instances, well-known features were omitted and/or simplified so as not to obscure claimed subject matter. While certain features have been illustrated and/or described herein, many modifications, substitutions, changes and/or equivalents will now occur to those skilled in the art. It is, therefore, to be understood that the appended claims are intended to cover all such modifications and/or changes as fall within the true spirit of invention as reflected by the preceding disclosure. It should further be understood that to the extent the term “invention” is used in the written specification, it is not to be construed as a limiting term as to number or type of claimed or disclosed inventions or the scope of any such invention and does not exclude discoveries or designs; rather, it is a term which has long been conveniently and widely used to describe new and useful improvements in technology.

What is claimed is:

1. A wearable device comprising a fall sensor responsive to a physical effect of a fall by a person wearing the device to generate a sensed-fall signal and a wireless transmitter capable of sending a wireless alert signal in response to the sensed-fall signal from the fall sensor without requiring participation of a person wearing the device, the improvement comprising:
the transmitter capable of receiving one or more ping signals and sending a response signal generated in response to receipt of the ping signal.

2. The wearable device of claim 1, further comprising:
a power management module comprising a battery and one or more charging contacts capable of charging the battery by induction charging.

3. The wearable device of claim 1, the fall sensor comprising an acceleration sensor adapted to measure a fall event by sensing a first period of time of a first activity having movement followed by sensing a second period of time of a second activity having relatively low movement in comparison to the first activity and/or substantially no movement.

4. The wearable device of claim 3, the device capable of measuring the time periods of the first activity and second activity and sensing a fall event based at least in part upon a duration of one or more of the time periods.

5. The wearable device of claim 1, the fall sensor capable of being calibrated for a user profile.

6. The wearable device of claim 5, the user profile comprising data selected from the group consisting essentially of: age, height, weight and one or more physical conditions of the user.

7. The wearable device of claim 3, the fall sensor capable of being calibrated to detect one or more substantially abrupt motions to indicate a stumble or misstep.

8. The wearable device of claim 4, the fall sensor capable of predicting one or more fall events based at least in part upon one or more of the measured time periods and/or a sequence of motion of the wearable device.

9. The wearable device of claim 3, the fall sensor capable of sensing horizontal and/or rotational motions of a fall event.

10. The wearable device of claim 1, the wearable device comprises a substantially water resistant bracelet.

11. The wearable device of claim 1, the wearable device comprises a substantially shock proof device.

12. The wearable device of claim 1 further comprising an audio chip capable of receiving voice communications from a user of the wearable device and converting the voice communications into one or more audio signals, the device capable of transmitting the audio signals with the transmitter.

13. The wearable device of claim 1 further comprising a location sensor, the device capable of transmitting location information to a remote database server with the transmitter.

14. The wearable device of claim 2, further comprising:
the device capable of generating an alert if the battery is low on power and transmitting the low battery alert with the transmitter.

15. The wearable device of claim 1, further comprising a wireless charging module that is capable of wireless charging of the battery with a wireless charger.

16. The wearable device of claim 1, the transmitter is a Bluetooth radio.

17. The wearable device of claim 1, further comprising a flex circuit.

18. A wearable device comprising:
a flex circuit and a cover within which the flex circuit may be placed, the cover comprising one or more hinged side arms capable of expanding and contracting so as to allow a user to put on the device, the flex circuit comprising:
an accelerometer capable of sensing the physical effects of a fall of a user wearing the device;
a processor capable of generating a sensed-fall alert in response to a sensed-fall event sensed by the accelerometer;
a transceiver capable of transmitting the sensed-fall alert, the transceiver capable of receiving a location ping signal and sending a response signal generated by the processor in response to receipt of the location ping signal;
an audio controller adapted for receiving one or more human voice communications and generating one or more voice signals in response to receipt of the human voice communications for wireless transmission by the transceiver;
a memory capable of storing data for retrieval and use by the processor, the memory adapted to be used by the processor in generating the alerts and/or the response signals and adapted for storing operating instructions for the wearable device;
a power management module comprising a battery adapted to provide power to the device and one or more charging contacts adapted for induction charging of the battery by an induction charging plate; and
a touch sensor capable of generating a manual alert in response to actuation of an actuator and the touch sensor capable of generating a cancellation signal to cancel the manual alert upon a second actuation of the actuator, the transceiver capable of transmitting the manual alert and the cancellation signal.

19. The wearable device of claim 18, the flex circuit further comprising a wireless charging module that is capable of wirelessly charging the battery remotely with a wireless charger.

20. The wearable device of claim 18, the transceiver comprising a Bluetooth radio.

21. The wearable device of claim 18, the flex circuit further comprising a GPS chip capable of being used to determine the location of the wearable device and the device capable of transmitting location information with the transceiver.

22. The wearable device of claim 18, further comprising a sensor capable of generating a cancellation signal in response to a waving motion of a user wearing the device.

23. The wearable device of claim 18, further comprising a hinge sensor capable of generating a manual alert in response to the expansion and contraction of the hinged side arm, the transceiver capable of transmitting the manual alert.

24. The wearable device of claim 18, the cover is substantially tamper resistant.

25. The wearable device of claim 18, the flex circuit comprising one or more ports into which an adapter for a device may be plugged, and the cover further comprising one or more openings through which the adapter may be plugged into the flex circuit.

26. The wearable device of claim 25, the port comprising a data port.

27. The wearable device of claim 18, the memory adapted for storing user profile information.

28. The wearable device of claim 18, the memory adapted for storing software and/or firmware containing operating instructions for the wearable device for generating the sensed-fall alert, the response signal, the manual alert and/or the cancellation signal.

29. The wearable device of claim 18, further comprising a recessed power switch.

30. The wearable device of claim 18, further comprising an LED illumination source.

31. The wearable device of claim 30, the LED illumination source having at least two illumination settings associated with at least two power modes of the wearable device.
